(19) United States
(12) Patent Application Publication
(10) Pub. No.: US 2025/0185021 A1
(43) Pub. Date: Jun. 5, 2025

(54) METHOD AND APPARATUS FOR TRANSMITTING DOWNLINK CONTROL INFORMATION, DEVICE, AND STORAGE MEDIUM

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 18/843,283

(22) PCT Filed: Mar. 3, 2022
(86) PCT No.: PCT/CN2022/079147

§ 371 Date: Sep. 2, 2024

(51) Int. Cl. H04W 72/232; H04W 72/0446; H04W 72/1263

(52) U.S. Cl. CPC H04W 72/232; H04W 72/0446; H04W 72/1263

(57) ABSTRACT

A method, apparatus and computer readable medium for transmitting downlink control information in a communication system. The downlink control information is transmitted by: sending indication information to user equipment, the indication information being configured to indicate a time domain characteristic of a common search space (CSS); and sending the downlink control information to the user equipment in the CSS according to the time domain characteristic.

### CROSS-REFERENCE TO RELATED APPLICATIONS

The present application is a U.S. National Stage of International Application No. PCT/CN2022/079147, filed on Mar. 3, 2022, the contents of all of which are incorporated herein by reference in their entirety for all purposes.

### BACKGROUND OF THE INVENTION

The R18 network energy-saving project aims to study a technology to reduce the energy consumption of the network device.

### SUMMARY OF THE INVENTION

In view of that, the disclosure provides a method and apparatus for transmitting downlink control information, a device, and a storage medium.

A first aspect of examples of the disclosure provides a method for sending downlink control information. The method is performed by a network device and includes:

sending indication information to user equipment, where the indication information is configured to indicate a time domain characteristic of a common search space (CSS); and

sending the downlink control information to the user equipment in the CSS according to the time domain characteristic.

A second aspect of examples of the disclosure provides a method for receiving downlink control information. The method is performed by user equipment and includes:

receiving indication information sent by a network device, where the indication information is configured to indicate a time domain characteristic of a common search space (CSS); and

receiving the downlink control information sent by the network device in the CSS according to the time domain characteristic.

A third aspect of examples of the disclosure provides a communication apparatus. The communication apparatus includes one or more processors and a memory. The one or more processors are collectively configured to:

send indication information to user equipment, wherein the indication information is configured to indicate a time domain characteristic of a common search space (CSS); and

send the downlink control information to the user equipment in the CSS according to the time domain characteristic.

A fourth aspect of examples of the disclosure provides a communication apparatus. The communication apparatus includes one or more processors and a memory.

The memory is configured to store a computer program.

The computer program when executed by the one or more processors cause the communication apparatus to execute the method for receiving downlink control information.

A fifth aspect of examples of the disclosure provides a non-transitory computer-readable storage medium, which stores an instruction. When the instruction is invoked and executed in a computer, the computer is caused to execute the method for sending downlink control information.

An sixth aspect of examples of the disclosure provides a non-transitory computer-readable storage medium, which stores an instruction. When the instruction is invoked and executed in a computer, the computer is caused to execute the method for receiving downlink control information.

It is to be understood that the above general description and the following detailed description are illustrative and explanatory, instead of limiting the disclosure.

### BRIEF DESCRIPTION OF DRAWINGS

The accompanying drawings described here serve to provide further understanding of examples of the disclosure and form part of the disclosure. Examples in the examples of the disclosure and their description serve to explain the examples of the disclosure and are not to be construed as unduly limiting the examples of the disclosure. In the drawings:

FIG. 1 is a schematic diagram of a framework of a radio communication system according to an example of the disclosure;

FIG. 2 is a flow diagram of a method for transmitting downlink control information according to an example;

FIG. 3 is a structural diagram of an apparatus for sending downlink control information according to an example;

FIG. 4 is a structural diagram of an apparatus for sending downlink control information according to an example;

FIG. 5 is a structural diagram of an apparatus for receiving downlink control information according to an example; and

FIG. 6 is a structural diagram of an apparatus for receiving downlink control information according to an example.

### DETAILED DESCRIPTION OF THE INVENTION

Examples of the disclosure are further described with reference to accompanying drawings and specific embodiments.

Examples will be described in detail here and shown in the accompanying drawings illustratively. When the following descriptions involve the accompanying drawings, unless otherwise specified, the same number in different accompanying drawings denotes the same or similar elements. The embodiments described in the following examples do not denote all embodiments consistent with the disclosure examples. On the contrary, the embodiments are merely instances of an apparatus and a method consistent with some aspects of the disclosure as detailed in the appended claims.

The terms used in the examples of the disclosure are merely to describe the specific examples, instead of limiting the examples of the disclosure. The singular forms such as “a,” “an” and “the” used in the examples of the disclosure and the appended claims are also intended to include the plural forms, unless otherwise clearly stated in the context. It is to be further understood that the term “and/or” used here refers to and includes any of one or more of the items listed in the associated list or all possible combinations.

It is to be understood that although the terms first, second, and third may be used to describe various information in the examples of disclosure, the information is not intended to be limited to the terms. The terms are merely used to distinguish the same type of information from each other. For instance, without departing from the scope of the examples of the disclosure, first information may also be called second information, and similarly, second information may also be called first information. Depending on the context, the words “if” and “under the condition” as used here can be interpreted as “when” or “at the time of” or “in response to determining”.

The examples of the disclosure are described in detail below, and the examples are illustratively shown in accompanying drawings, throughout which identical or similar reference numerals denote identical or similar elements. The examples described with reference to the accompanying drawings are illustrative and only intended to explain the disclosure, instead of limiting the disclosure.

The disclosure relates to the technical field of radio communication, and particularly relates to a method and apparatus for transmitting downlink control information, a device, and a storage medium.

When user equipment accesses a cell in new radio (NR), 3-5 synchronization signal blocks (SSBs) generally need to be monitored to achieve synchronization accuracy, and then a Type #0 common search space (CSS) needs to be monitored and demodulated.

When a multiplexing pattern for a network device to send an SSB and a control resource set (CORESET) is SSB/CORESET 0 multiplexing pattern 2/3, the Type #0 CSS has the same period as the SSB; and when the multiplexing pattern is SSB/CORESET 0 multiplexing pattern 1, the period of the Type #0 CSS is fixed at 20 ms.

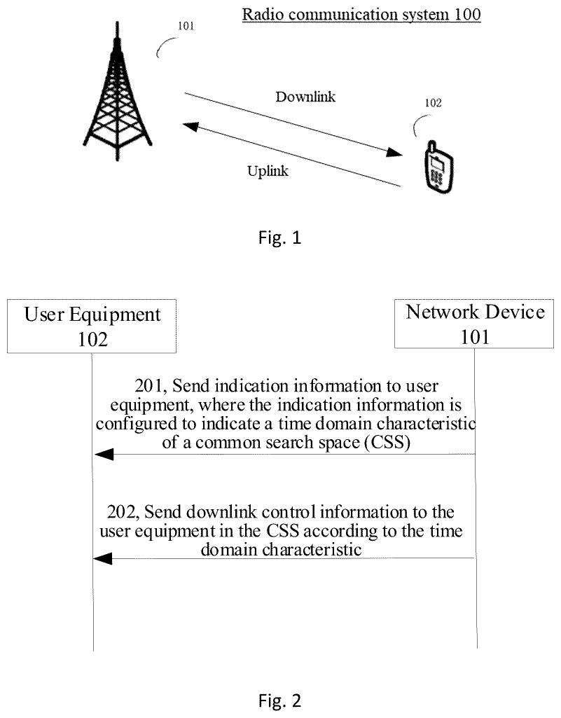

As shown in FIG. 1, a method for transmitting downlink control information according to an example of the disclosure may be performed by a radio communication system 100. The radio communication system 100 may include, but is not limited to, a network device 101 and user equipment 102. The user equipment 102 is configured to support carrier aggregation. The user equipment 102 may be connected to a plurality of carrier units of the network device 101, which include a main carrier unit and one or more auxiliary carrier units.

It is to be understood that the radio communication system 100 may be applied to both a low-frequency scene and a high-frequency scene. Application scenes of the radio communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, a future evolved public land mobile network (PLMN) system, etc.

The above user equipment 102 may be user equipment (UE), a terminal, an access terminal, a terminal unit, a terminal station, a mobile station (MS), a remote station, a remote terminal, a mobile terminal, a radio communication device, a terminal agent, user equipment, etc. The user equipment 102 may have a radio transceiving function, and may be in communication (for instance, radio communication) with one or more network devices 101 of one or more communication systems and receive a network service provided by the network device 101. The network device 101 here includes, but is not limited to, a base station illustrated.

The user equipment 102 may be a cell phone, a cordless phone, a session initiation protocol (SIP) phone, a wireless local loop (WLL) station, a personal digital assistant (PDA) device, a handheld device having a radio communication function, a computing device or other processing devices connected to a radio modem, a vehicular device, a wearable device, user equipment in a future 5G network, user equipment in a future evolved PLMN, etc.

The network device 101 may be an access network device (or an access network site). The access network device refers to a device providing a network access function, such as a radio access network (RAN) base station. The network device may specifically include a base station (BS) device, or include a base station device and a radio resource management device configured to control the base station device. The network device may further include a relay station (a relay device), an access point, a base station in the future 5G network, a base station in the future evolved PLMN, an NR base station, etc. The network device may be a wearable device or a vehicular device. Alternatively, the network device may be a communication chip having a communication module.

For instance, the network device 101 includes, but is not limited to, gnodeB (gNB) in 5G, an evolved node B (eNB) in the LTE system, a radio network controller (RNC), a node B (NB) in a wideband code division multiple access (WCDMA) system, a radio controller in the CRAN system, a base station controller (BSC), a base transceiver station (BTS) in a GSM system or a code division multiple access (CDMA) system, a home base station (for instance, a home evolved nodeB or a home node B (HNB)), a baseband unit (BBU), a transmitting and receiving point (TRP), a transmitting point (TP), a mobile switching center, etc.

The R18 network energy saving project aims to study a technology to reduce energy consumption of the network device. A method of reducing energy consumption of the network device is to reduce unnecessary broadcast signals.

Thus, it is necessary to design a method for transmitting downlink control information, such that unnecessary broadcasting of the network device can be reduced, and further energy consumption of the network device can be reduced.

In the method, the indication information indicating the time domain characteristic of the CSS is sent to the user equipment by the network device, and the downlink control information is sent in a CSS based on the time domain characteristic; and the downlink control information in the CSS is received by the user equipment based on the time domain characteristic indicated in the indication information. No matter whether the time domain characteristic is periodic or aperiodic, unnecessary broadcasting of the network device can be reduced, and further energy consumption of the network device can be reduced.

An example of the disclosure provides a method for transmitting downlink control information. FIG. 2 is a flow diagram of a method for transmitting downlink control information according to an example. As shown FIG. 2, the method includes the following steps:

Step 201, indication information is sent to user equipment.

The indication information sent by a network device is configured to indicate a time domain characteristic of a common search space (CSS). The indication information sent by the network device is received by the user equipment.

In an embodiment of the disclosure, the CSS is Type #0CSS. The Type #0CSS is a common control information search space, configured to carry downlink control information (DCI) of scheduling system information, broadcast by the network device. CORESET 0 is a physical resource collection corresponding to the Type #0 CSS.

In an embodiment of the disclosure, the time domain characteristic is periodic. That is, the CSS is periodically sent to the user equipment by the network device, and the CSS is periodically received by the user equipment.

In an embodiment of the disclosure, in a scene where the CSS is periodically sent to the user equipment by the network device, the indication information indicates period information of sending the CSS by the network device. In this way, after the user equipment receives the indication information, the CSS is received based on the period information indicated by the indication information, such that the CSS can be conveniently received by the user equipment.

In an embodiment of the disclosure, in a scene where the CSS is periodically sent to the user equipment by the network device, a multiplexing pattern for the network device to send a synchronization signal block (SSB) and the CSS is a first pattern, and a period of sending the CSS by the network device is N*20 ms. N is a positive integer greater than 1. For instance, the first pattern here is multiplexing pattern 1.

In an embodiment of the disclosure, in a scene where the CSS is periodically sent to the user equipment by the network device, a multiplexing pattern for the network device to send the SSB and the CSS is a second pattern, and a period of sending the CSS by the network device is N*T. T is a period of sending the SSB. N is a positive integer greater than 1. For instance, the second pattern here is multiplexing pattern 2 or multiplexing pattern 3.

In the embodiment, when the user equipment accesses a cell, 3-5 SSBs generally need to be monitored to achieve synchronization accuracy, and then a Type #0 CSS needs to be monitored and demodulated. Thus, a period of sending the CSS by the network device, that is, a period of sending the Type #0 CSS, may be N times as long as a period of sending the Type #0 CSS defined in an R15 protocol. In this way, the Type #0 CSS is sent by the network device with a long period, such that a frequency of sending the Type #0 CSS can be reduced, and further energy consumption of the network device can be reduced. Moreover, in the embodiment, the period of sending the Type #0 CSS by the network device rather than the period of sending the SSB by the network device is prolonged, such that extra time for initial access of the user equipment can be avoided to the greatest extent.

For instance, in a scene where the CSS is periodically sent to the user equipment by the network device and the SSB and the CSS are sent by the network device in the second pattern, that is, the multiplexing pattern 2 or the multiplexing pattern 3, N is 2, that is, the period of sending the Type #0 CSS by the network device is 2 times as long as the period of sending the SSB. If the user equipment achieves synchronization after a first SSB, a second SSB and a third SSB are monitored and the Type #0 CSS is sent by the network device in a first SSB period, a third SSB period, a fifth SSB period, etc., the Type #0 CSS is monitored by the user equipment in the third SSB period. In the scene, when the user equipment accesses the cell, time required for monitoring the Type #0 CSS is 3 times as long as the period of sending the SSB by the network device.

For instance, in a scene where the CSS is periodically sent to the user equipment by the network device and the SSB and the CSS are sent by the network device in the second pattern, that is, the multiplexing pattern 2 or the multiplexing pattern 3, N is 2, that is, the period of sending the Type #0 CSS by the network device is 2 times as long as the period of sending the SSB. If the user equipment achieves synchronization after a first SSB, a second SSB and a third SSB are monitored and the Type #0 CSS is sent by the network device in a second SSB period, a fourth SSB period, a sixth SSB period, etc., the Type #0 CSS is monitored by the user equipment in the fourth SSB period. In the scene, when the user equipment accesses the cell, time required for monitoring the Type #0 CSS is 4 times as long as the period of sending the SSB by the network device.

In contrast, the period of sending the SSB and the period of sending the Type #0 CSS are synchronously prolonged by 2 times by the network device, and new periods are obtained. If the user equipment achieves synchronization after a first SSB, a second SSB and a third SSB are monitored, the Type #0 CSS is monitored by the user equipment in a third new period. In the scene, during access of the user equipment, time required for monitoring the Type #0 CSS is 6 times as long as the period of sending the SSB by the network device before the period of sending the SSB and the period of sending the Type #0 CSS are not synchronously prolonged. It can be seen from the above description that the time required for access of the user equipment in the solution is longer than the time required in the above embodiment of the disclosure.

In an embodiment of the disclosure, in a scene where the CSS is periodically sent to the user equipment by the network device, the indication information is carried in a reserved bit of a physical broadcast channel (PBCH). In this way, the indication information is sent through the reserved bit of the PBCH, such that the PBCH is fully used.

For instance, in the scene where the CSS is periodically sent to the user equipment by the network device, the indication information is transmitted through 1 bit reserved in the PBCH. For instance, if a value of the 1 bit is “1,” it is indicated that the period of sending the Type #0 CSS by the network device is N times as long as the period defined in the R15. A value of N here is defined by a communication protocol. If a value of the 1 bit is “0,” it is indicated that the network device still uses the period defined in the R15 to send the Type #0 CSS.

For instance, in the scene where the CSS is periodically sent to the user equipment by the network device, the indication information is transmitted through a plurality of bits reserved in the PBCH. A plurality of values formed by the plurality of bits may indicate a plurality of values of N. For instance, the indication information is transmitted through 2 bit reserved in the PBCH. Further, for instance, if a value of the 2 bit is “00,” it is indicated that the period of sending the Type #0 CSS by the network device is 2 times as long as the period defined in the R15. If a value of the 2 bit is “01,” it is indicated that the period of sending the Type #0 CSS by the network device is 3 times as long as the period defined in the R15. If a value of the 2 bit is “10,” it is indicated that the period of sending the Type #0 CSS by the network device is 4 times as long as the period defined in the R15. If a value of the 2 bit is “11,” it is indicated that the period of sending the Type #0 CSS by the network device is the period defined in the R15.

In an embodiment of the disclosure, in a scene where the CSS is periodically sent to the user equipment by the network device, the indication information is carried in a reserved domain of a main information block (MIB) of the PBCH. For instance, the indication information is carried in a reserved 1 bit of the MIB of the PBCH, and a value of N is defined by a communication protocol or configured by a base station.

In an embodiment of the disclosure, in a scene where the CSS is periodically sent to the user equipment by the network device, the indication information is carried in a reserved bit of a physical layer in a set frequency band in the PBCH. The set frequency band is an FR1 frequency band. A frequency range of the FR1 frequency band is 410 MHz-7125 MHz. For instance, the reserved bit of the physical layer in the FR1 frequency band is 1 bit or 2 bit, which indicates one or more values of N. The one or more values are defined by the communication protocol or configured by the base station.

In an embodiment of the disclosure, in a scene where the CSS is periodically sent to the user equipment by the network device, the indication information is carried in a reserved bit of a spare information domain for message extension in the PBCH. For instance, the indication information is carried in a reserved 1 bit of the spare information domain for message extension in the PBCH, and a value of N is defined by a communication protocol or configured by a base station.

In the embodiment, through the reserved bit of the PBCH, the value of N is transmitted with fewer bits, such that transmission efficiency of information is improved.

In an embodiment of the disclosure, the time domain characteristic is aperiodic. That is, the CSS is aperiodically sent to the user equipment by the network device.

In an embodiment of the disclosure, in a scene where the CSS is aperiodically sent to the user equipment by the network device, the indication information is configured to indicate whether to send the CSS within first duration and second duration. The first duration is a time period before sending a current SSB. The second duration is a time period after sending the current SSB. That is, the indication information here indicates whether a CSS corresponding to an SSB currently sent exists, that is, the Type #0 CSS. The first duration and the second duration here may be set according to the period of sending the SSB by the network device, which are not repeated here.

In an embodiment of the disclosure, in a scene where the CSS is aperiodically sent to the user equipment by the network device, the indication information is configured to indicate whether to send the CSS within a radio frame where a current SSB is located. That is, the indication information here indicates whether the CSS corresponding to the SSB currently sent exists.

In the embodiment, the Type #0 CSS is aperiodically sent to the user equipment by the network device, that is, the Type #0 CSS is not sent in each period of sending the SSB by the network device, such that a frequency of sending the Type #0 CSS can be reduced, and further energy consumption of the network device can be reduced. In addition, the Type #0 CSS is aperiodically sent to the user equipment by the network device, so the network device needs to indicate an opportunity to monitor the Type #0 CSS by the user equipment with the indication information, such that the user equipment conveniently monitors the Type #0 CSS.

It is to be noted that NR has an SSB that is used for radio resource management (RRM) measurement rather than cell access. The SSB for the purpose may have no corresponding Type #0 CSS, and may be called a non-cell defined-SSB (NCD-SSB). At present, whether the SSB of the cell at the frequency point is the NCD-SSB is determined by a subcarrier offset parameter (that is, KSSB) between the SSB carried in the PBCH and a common resource block grid. If the KSSB is 0-11 for an FR2 frequency band and the KSSB is 0-23 for the FR1 frequency band, it is determined that the SSB of the cell at this frequency point is a cell-defined SSB (CD-SSB). Otherwise, the SSB is an NCD-SSB.

However, in the embodiment of the disclosure, the indication information indicates whether the CSS corresponding to the SSB currently sent exists, and does not indicate whether the SSB currently sent is the CD-SSB or the NCD-SSB.

It may be understood that the situation in the embodiment of the disclosure exists as follows: no corresponding Type #0 CSS exists on some transmission periods of the CD-SSB, and a corresponding Type #0 CSS exists on other transmission periods.

In an embodiment of the disclosure, in a scene where the CSS is aperiodically sent to the user equipment by the network device, the indication information is carried in a reserved bit of the PBCH. In this way, the indication information is transmitted through the reserved bit of the PBCH, such that the PBCH is fully used.

For instance, in the scene where the CSS is aperiodically sent to the user equipment by the network device, the indication information is transmitted through 1 bit reserved in the PBCH. For instance, if a value of the 1 bit is “1,” it is indicated that the Type #0 CSS corresponding to the SSB currently sent exists. If a value of the 1 bit is “0,” it is indicated that no Type #0 CSS corresponding to the SSB currently sent exists.

In an embodiment of the disclosure, in a scene where the CSS is aperiodically sent to the user equipment by the network device, the indication information is carried in the reserved domain of the MIB of the PBCH. For instance, the indication information is carried in the reserved 1 bit of the MIB of the PBCH.

In an embodiment of the disclosure, in a scene where the CSS is aperiodically sent to the user equipment by the network device, the indication information is carried in the reserved bit of the physical layer in the set frequency band in the PBCH. The set frequency band is the FR1 frequency band. For instance, the indication information is carried in a reserved 1 bit of a physical layer in the FR1 frequency band of the PBCH.

In an embodiment of the disclosure, in a scene where the CSS is aperiodically sent to the user equipment by the network device, the indication information is carried in the reserved bit of the spare information domain for message extension in the PBCH. For instance, the indication information is carried in a reserved 1 bit of the spare information domain for message extension in the PBCH.

Step 202, the downlink control information is sent to the user equipment in the CSS according to the time domain characteristic.

The indication information is received by the user equipment, and the downlink control information sent by the network device in the CSS is received according to the time domain characteristic indicated by the indication information. As mentioned above, the Type #0 CSS is a search space, configured to carry the downlink control information, broadcast by the network device. If the downlink control information is sent by the network device in the Type #0 CSS, the downlink control information in the Type #0 CSS is received by the user equipment.

Through the method of the disclosure, the indication information indicating the time domain characteristic of the CSS is sent to the user equipment by the network device, and the downlink control information is sent in a CSS based on the time domain characteristic; and the downlink control information in the CSS is received by the user equipment based on the time domain characteristic indicated in the indication information. No matter whether the time domain characteristic is periodic or aperiodic, unnecessary broadcasting of the network device can be reduced, and further energy consumption of the network device can be reduced.

In an embodiment of the disclosure, when the CSS is periodically sent by the network device, a multiplexing pattern for the network device to send the SSB and the CSS is a first pattern, and the first pattern is multiplexing pattern 1.

In an embodiment of the disclosure, when the CSS is periodically sent by the network device, a multiplexing pattern for the network device to sent the SSB and the CSS is a second pattern, and the second pattern is multiplexing pattern 2.

In an embodiment of the disclosure, when the CSS is periodically sent by the network device, a multiplexing pattern for the network device to send the SSB and the CSS is a second pattern, and the second pattern is multiplexing pattern 3.

In the embodiment, when the CSS is periodically sent by the network device, the multiplexing pattern for the network device to send the SSB and the CSS may be any one of multiplexing pattern 1, multiplexing pattern 2, and multiplexing pattern 3.

In an embodiment of the disclosure, when the CSS is aperiodically sent by the network device, a multiplexing pattern for the network device to send the SSB and the CSS is a second pattern, and the second pattern is multiplexing pattern 2.

In an embodiment of the disclosure, when the CSS is aperiodically sent by the network device, a multiplexing pattern for the network device to send the SSB and the CSS is a second pattern, and the second pattern is multiplexing pattern 3.

In the embodiment, when the CSS is aperiodically sent by the network device, the multiplexing pattern for the network device to send the SSB and the CSS may be either of multiplexing pattern 2 and multiplexing pattern 3.

The disclosure provides a method for sending downlink control information. The method is performed by a network device and includes:

sending indication information to user equipment, where the indication information is configured to indicate a time domain characteristic of a common search space (CSS); and

sending the downlink control information to the user equipment in the CSS according to the time domain characteristic.

In some possible embodiments, the time domain characteristic is period information of the CSS.

In some possible embodiments, in response to determining that a multiplexing pattern of a synchronization signal block (SSB) and the CSS is a first pattern, a period of the CSS is N*20 ms; or,

in response to determining that a multiplexing pattern of an SSB and the CSS is a second pattern, a period of the CSS is N*T, and T is a period of transmitting the SSB;

where N is a positive integer greater than 1.

In some possible embodiments, in response to determining that a multiplexing pattern of an SSB and the CSS is a second pattern, the time domain characteristic is an aperiodic characteristic.

In some possible embodiments, the indication information is further configured to indicate whether to send the CSS within first duration and second duration. The first duration is a time period before sending a current SSB. The second duration is a time period after sending the current SSB.

In some possible embodiments, the indication information is further configured to indicate whether to send the CSS within a radio frame where a current SSB is located.

In some possible embodiments, the indication information is carried in a reserved bit of a physical broadcast channel (PBCH).

In some possible embodiments, the indication information is carried in the reserved bit of the PBCH as follows:

the indication information is carried in a reserved domain of a main information block of the PBCH; or,

the indication information is carried in a reserved bit of a physical layer in an FR1 (Frequency Range 1) frequency band of the PBCH.

The disclosure provides a method for receiving downlink control information. The method is performed by user equipment and includes:

receiving indication information sent by a network device, where the indication information is configured to indicate a time domain characteristic of a common search space (CSS); and

receiving the downlink control information sent by the network device in the CSS according to the time domain characteristic.

In some possible embodiments, the time domain characteristic is period information of the CSS.

In some possible embodiments, in response to determining that a multiplexing pattern of a synchronization signal block (SSB) and the CSS is a first pattern, a period of the CSS is N*20 ms; or,

in response to determining that a multiplexing pattern of an SSB and the CSS is a second pattern, a period of the CSS is N*T, and T is a period of sending the SSB by the network device;

where N is a positive integer greater than 1.

In some possible embodiments, in response to determining that a multiplexing pattern of an SSB and the CSS is a second pattern, the time domain characteristic is an aperiodic characteristic.

In some possible embodiments, the indication information is further configured to indicate whether to send the CSS within first duration and second duration. The first duration is a time period before sending a current SSB. The second duration is a time period after sending the current SSB.

In some possible embodiments, the indication information is further configured to indicate whether to send the CSS within a radio frame where a current SSB is located.

In some possible embodiments, the indication information is carried in a reserved bit of a physical broadcast channel (PBCH).

In some possible embodiments, the indication information is carried in the reserved bit of the PBCH as follows:

the indication information is carried in a reserved domain of a main information block of the PBCH; or,

the indication information is carried in a reserved bit of a physical layer in an FR1 frequency band of the PBCH.

According to the same concept as the above method embodiment, an example of the disclosure further provides a communication apparatus. The communication apparatus may have functions of the network device in the above method embodiment, and is configured to execute steps performed by the network device according to the above embodiment. The functions may be achieved by hardware or software, or by executing corresponding software with hardware. The hardware or software includes one or more modules corresponding to the above functions.

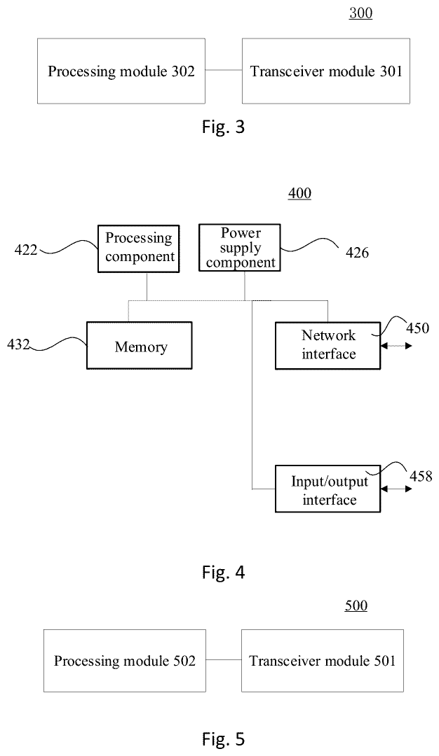

In a possible embodiment, a communication apparatus 300 shown in FIG. 3 may be used as the network device involved in the above method embodiment, and execute steps performed by the network device in the above method embodiment. As shown in FIG. 3, the communication apparatus 300 may include a transceiver module 301 and a processing module 302. The transceiver module 301 is coupled to the processing module 302. The transceiver module 301 may be configured to support communication of the communication apparatus 300. The transceiver module 301 may have a radio communication function, and for instance, may be in radio communication with other communication apparatuses through New Radio. The processing module 302 may be configured to enable the communication apparatus 300 to execute processing operations in the above method embodiment. The processing operations include, but are not limited to, generation of information and messages sent by the transceiver module 301, and/or demodulation and decoding of signals received by the transceiver module 801.

When the step implemented by the network device is executed, the transceiver module 301 is configured to send indication information to user equipment, where the indication information is configured to indicate a time domain characteristic of a CSS; and to send the downlink control information to the user equipment in the CSS according to the time domain characteristic.

In some possible embodiments, the time domain characteristic is period information of the CSS.

In some possible embodiments, a multiplexing pattern of a synchronization signal block (SSB) and the CSS is a first pattern, and a period is N*20 ms; or,

a multiplexing pattern of an SSB and the CSS is a second pattern, a period is N*T, and T is a period of sending the SSB;

where N is a positive integer greater than 1.

In some possible embodiments, in response to determining that a multiplexing pattern of an SSB and the CSS is a second pattern, the time domain characteristic is an aperiodic characteristic.

In some possible embodiments, the indication information is further configured to indicate whether to send the CSS within first duration and second duration. The first duration is a time period before sending a current SSB. The second duration is a time period after sending the current SSB.

In some possible embodiments, the indication information is further configured to indicate whether to send the CSS within a radio frame where a current SSB is located.

In some possible embodiments, the indication information is carried in a reserved bit of a physical broadcast channel (PBCH).

In some possible embodiments, the indication information is carried in the reserved bit of the PBCH as follows:

the indication information is carried in a reserved domain of a main information block of the PBCH; or,

the indication information is carried in a reserved bit of a physical layer in an FR1 frequency band of the PBCH.

When the communication apparatus is the network device, a structure of the communication apparatus may also be shown as an apparatus 400. For instance, the apparatus 400 may be a base station. With reference to FIG. 4, the apparatus 400 includes a processing component 422, which further includes one or more processors, and a memory resource represented by a memory 432, which is configured to store an instruction executable by the processing component 422, such as an application. The application stored in the memory 432 may include one or more modules that each correspond to a group of instructions. In addition, the processing component 422 is configured to execute the instruction, such that the method for transmitting downlink control information is executed.

The apparatus 400 may further include a power supply component 426 configured to execute power management of the apparatus 400, a wired or radio network interface 450 configured to connect the apparatus 400 to a network, and an input/output (I/O) interface 459. The apparatus 400 may operate based on an operating system stored in the memory 432, such as Windows Server™, Mac OS X™, Unix™, Linux™, and FreeBSD™.

According to the same concept as the above method embodiment, an example of the disclosure further provides a communication apparatus. The communication apparatus may have functions of the user equipment in the above method embodiment, and is configured to execute steps performed by the user equipment according to the above embodiment. The functions may be achieved by hardware or software, or by executing corresponding software with hardware. The hardware or software includes one or more modules corresponding to the above functions.

In a possible embodiment, a communication apparatus 500 shown in FIG. 5 may be used as the user equipment involved in the above method embodiment, and execute steps performed by the user equipment in the above method embodiment. As shown in FIG. 5, the communication apparatus 500 may include a transceiver module 501 and a processing module 502. The transceiver module 501 is coupled to the processing module 502. The transceiver module 501 may be configured to support communication of the communication apparatus 500. The transceiver module 501 may have a radio communication function, and for instance, may be in radio communication with other communication apparatuses through New Radio. The processing module 502 may be configured to enable the communication apparatus 500 to execute processing operations in the above method embodiment. The processing operations include, but are not limited to, generation of information and messages transmitted by the transceiver module 501, and/or demodulation and decoding of signals received by the transceiver module 501.

When the step implemented by the user equipment is executed, the transceiver module 501 is configured to receive indication information, where the indication information is configured to indicate a time domain characteristic of a common search space (CSS); and to receive the downlink control information sent by the network device in the CSS according to the time domain characteristic.

In some possible embodiments, the time domain characteristic is period information of the CSS.

In some possible embodiments, a multiplexing pattern of a synchronization signal block (SSB) and the CSS is a first pattern, and a period is N*20 ms; or,

a multiplexing pattern of an SSB and the CSS is a second pattern, a period is N*T, and T is a period of sending the SSB;

where N is a positive integer greater than 1.

In some possible embodiments, in response to determining that a multiplexing pattern of an SSB and the CSS is a second pattern, the time domain characteristic is an aperiodic characteristic.

In some possible embodiments, the indication information is further configured to indicate whether to send the CSS within first duration and second duration. The first duration is a time period before sending a current SSB. The second duration is a time period after sending the current SSB.

In some possible embodiments, the indication information is further configured to indicate whether to send the CSS within a radio frame where a current SSB is located.

In some possible embodiments, the indication information is carried in a reserved bit of a physical broadcast channel (PBCH).

In some possible embodiments, the indication information is carried in the reserved bit of the PBCH as follows:

the indication information is carried in a reserved domain of a main information block of the PBCH; or,

the indication information is carried in a reserved bit of a physical layer in an FR1 frequency band of the PBCH.

When the communication apparatus is the user equipment, a structure of the communication apparatus may also be shown as an apparatus 600. For instance, the apparatus 600 may be a mobile phone, a computer, a digital broadcast terminal, a messaging device, a game console, a tablet device, a medical device, a fitness device, a personal digital assistant, etc.

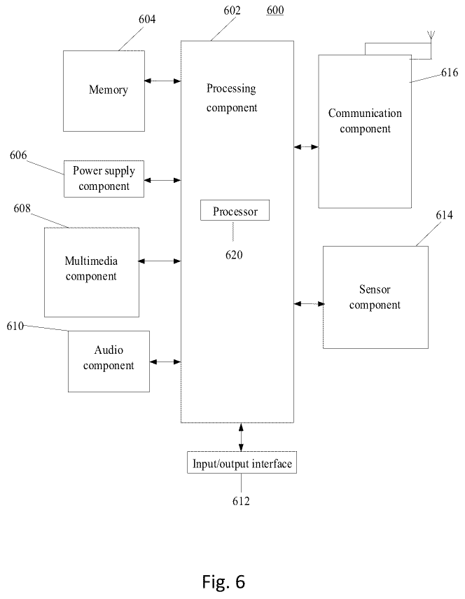

With reference to FIG. 6, the apparatus 600 may include one or more of the following components: a processing component 602, a memory 604, a power supply component 606, a multimedia component 608, an audio component 610, an input/output (I/O) interface 612, a sensor component 614, and a communication component 616.

The processing component 602 generally controls all operations of the apparatus 600, such as operations associated with display, telephone call, data communication, camera operation and recording operation. The processing component 602 may include one or more processors 620 configured to execute an instruction, so as to complete all or some steps of the method. In addition, the processing component 602 may include one or more modules to facilitate interaction between the processing component 602 and other components. For instance, the processing component 602 may include a multimedia module to facilitate interaction between the multimedia component 608 and the processing component 602.

The memory 604 is configured to store various types of data to support the operations on the apparatus 600. Instances of the data include an instruction for any application or method operating on the apparatus 600, contact data, phone book data, a message, a picture, a video, etc. The memory 604 may be implemented by any type of volatile or nonvolatile memory device or their combinations, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk, or an optical disk.

The power supply component 606 supplies power to various components of the apparatus 600. The power supply component 606 may include a power management system, one or more power supplies, and other components associated with generating, managing and distributing power for the apparatus 600.

The multimedia component 608 includes a screen that provides an output interface between the apparatus 600 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, slide and gestures on the touch panel. The touch sensor may sense a boundary of a touch or slide operation, and detect duration and pressure related to the touch or slide operation. In some examples, the multimedia component 608 includes a front-facing camera and/or a rear-facing camera. When the apparatus 600 is in an operation mode, such as a photographing mode or a video mode, the front-facing camera and/or the rear-facing camera are/is capable of receiving external multimedia data. Each of the front-facing camera and the rear-facing camera may be a fixed optical lens system or have a focal length and an optical zoom capability.

The audio component 610 is configured to output and/or input an audio signal. For instance, the audio component 610 includes a microphone (MIC). The microphone is configured to receive an external audio signal when the apparatus 600 is in operation modes such as a call mode, a recording mode and a speech identification mode. The received audio signal may be further stored in the memory 604 or transmitted via the communication component 616. In some examples, the audio component 610 further includes a speaker configured to output an audio signal.

The I/O interface 612 provides an interface between the processing component 602 and a peripheral interface module. The peripheral interface module may be a keyboard, a click wheel, a button, etc. The buttons may include, but are not limited to, a home button, a volume button, a start button, and a lock button.

The sensor component 614 includes one or more sensors for providing various aspects of state assessment for the apparatus 600. For instance, the sensor component 614 may detect an on/off state of the apparatus 600 and relative positioning of the components such as a display and a keypad of the apparatus 600, and the sensor component 614 may further detect position change of the apparatus 600 or a component of the apparatus 600, presence or absence of contact between the user and the apparatus 600, an orientation or acceleration/deceleration of the apparatus 600 and temperature change of the apparatus 600. The sensor component 614 may include a proximity sensor configured to detect presence of a nearby object without any physical contact. The sensor component 614 may further include an optical sensor, such as a complementary metal-oxide-semiconductor (CMOS) or charge-coupled device (CCD) image sensor, which is used in imaging application. In some examples, the sensor component 614 may further include an acceleration sensor, a gyroscope sensor, a magnetic sensor, a pressure sensor, or a temperature sensor.

The communication component 616 is configured to facilitate wired or radio communication between the apparatus 600 and other devices. The apparatus 600 may access a radio network based on a communication standard, such as WiFi, the 2nd generation mobile communication technology (2G) or the 3rd generation mobile communication technology (3G), or their combinations. In an example, the communication component 616 receives a broadcast signal or broadcast related information from an external broadcast management system via a broadcast channel. In an example, the communication component 616 further includes a near field communication (NFC) module to facilitate short-range communication. For instance, the NFC module may be implemented based on a radio frequency identification (RFID) technology, an infrared data association (IrDA) technology, an ultra wide band (UWB) technology, a Bluetooth (BT) technology or other technologies.

In an example, the apparatus 600 may be implemented by one or more of an application specific integrated circuit (ASIC), a digital signal processor (DSP), a digital signal processing device (DSPD), a programmable logic device (PLD), a field programmable gate array (FPGA), a controller, a microcontroller, a microprocessor or other electronic components, thus executing the method.

An example further provides a non-transitory computer-readable storage medium including an instruction, such as the memory 604 including an instruction. The instruction may be performed by the processor 620 of the apparatus 600 so as to complete the method. For instance, the non-transitory computer-readable storage medium may be ROM, a random access memory (RAM), CD-ROM, a magnetic tape, a floppy disk, an optical data storage device, etc.

Those skilled in the art could easily conceive of other implementation solutions of the examples of the disclosure upon consideration of the description and the invention disclosed here. The disclosure is intended to cover any variations, uses or adaptive changes of the disclosure, which follow the general principles of the disclosure and include common general knowledge or conventional technical means in the technical field not disclosed in the disclosure.

It is to be understood that the examples of the disclosure are not limited to a precise structure described above and illustrated in the accompanying drawings, and can have various modifications and changes without departing from the scope.

Indication information indicating a time domain characteristic of a CSS is sent to user equipment by a network device, and downlink control information is sent in a CSS based on the time domain characteristic; and the downlink control information in the CSS is received by the user equipment based on the time domain characteristic indicated in the indication information. No matter whether the time domain characteristic is periodic or aperiodic, unnecessary broadcasting of the network device can be reduced, and further energy consumption of the network device can be reduced.

1. A method for sending downlink control information, performed by a network device, comprising:
sending indication information to user equipment, wherein the indication information is configured to indicate a time domain characteristic of a common search space (CSS); and
sending the downlink control information to the user equipment in the CSS according to the time domain characteristic.

2. The method according to claim 1, wherein the time domain characteristic is period information of the CSS.

3. The method according to claim 2, wherein
a multiplexing pattern of a synchronization signal block (SSB) and the CSS is a first pattern, and a period of the CSS is N*20 ms; or,
a multiplexing pattern of an SSB and the CSS is a second pattern, a period of the CSS is N*T, and T is a period of sending the SSB;
wherein N is a positive integer greater than 1.

4. The method according to claim 1, wherein a multiplexing pattern of an SSB and the CSS is a second pattern, the time domain characteristic is an aperiodic characteristic.

5. The method according to claim 1, wherein the indication information is further configured to indicate whether to send the CSS within first duration and second duration, the first duration is a time period before sending a current SSB, and the second duration is a time period after sending the current SSB.

6. The method according to claim 1, wherein the indication information is further configured to indicate whether to send the CSS within a radio frame where a current SSB is located.

7. The method according to claim 1, wherein the indication information is carried in a reserved bit of a physical broadcast channel (PBCH).

8. The method according to claim 7, wherein the indication information is carried in the reserved bit of the PBCH as follows:
the indication information is carried in a reserved domain of a main information block of the PBCH; or,
the indication information is carried in a reserved bit of a physical layer in an FR1 (Frequency Range 1) frequency band of the PBCH.

9. A method for receiving downlink control information, performed by user equipment, comprising:
receiving indication information sent by a network device, wherein the indication information is configured to indicate a time domain characteristic of a common search space (CSS); and
receiving the downlink control information sent by the network device in the CSS according to the time domain characteristic.

10. The method according to claim 9, wherein the time domain characteristic is period information of the CSS.

11. The method according to claim 10, wherein
a multiplexing pattern of a synchronization signal block (SSB) and the CSS is a first pattern, a period of the CSS is N*20 ms; or,
a multiplexing pattern of an SSB and the CSS is a second pattern, a period of the CSS is N*T, and T is a period of sending the SSB by the network device;
wherein N is a positive integer greater than 1.

12. The method according to claim 9, wherein a multiplexing pattern of an SSB and the CSS is a second pattern, the time domain characteristic is an aperiodic characteristic.

13. The method according to claim 9, wherein the indication information is further configured to indicate whether to send the CSS within first duration and second duration, the first duration is a time period before sending a current SSB, and the second duration is a time period after sending the current SSB.

14. The method according to claim 9, wherein the indication information is further configured to indicate whether to send the CSS within a radio frame where a current SSB is located.

15. The method according to claim 9, wherein the indication information is carried in a reserved bit of a physical broadcast channel (PBCH).

16. The method according to claim 15, wherein the indication information is carried in the reserved bit of the PBCH as follows:
the indication information is carried in a reserved domain of a main information block of the PBCH; or,
the indication information is carried in a reserved bit of a physical layer in an Frequency Range 1 (FR1) frequency band of the PBCH.

17.-18. (canceled)

19. A communication apparatus, comprising one or more processors and a memory, wherein
the one or more processors are collectively
configured to:
send indication information to user equipment, wherein the indication information is configured to indicate a time domain characteristic of a common search space (CSS); and
send downlink control information to the user equipment in the CSS according to the time domain characteristic.

20. A communication apparatus, comprising one or more processors and a memory, wherein
the memory is configured to store a computer program; and
the computer program when executed by the one or more processors cause the communication apparatus to execute the method according to claim 9.

21. A non-transitory computer-readable storage medium, storing an instruction, wherein when the instruction is invoked and executed in a computer, the computer is caused to execute the method according to claim 1.

22. A non-transitory computer-readable storage medium, storing an instruction, wherein when the instruction is invoked and executed in a computer, the computer is caused to execute the method according to claim 9.
